(19) United States
(12) Patent Application Publication
(10) Pub. No.: US 2020/0242832 A1
(43) Pub. Date: Jul. 30, 2020

(54) IMAGE PROCESSING DEVICE, DISPLAY DEVICE, IMAGE TRANSMISSION DEVICE, IMAGE PROCESSING METHOD, CONTROL PROGRAM, AND RECORDING MEDIUM

(71) Applicant: SHARP KABUSHIKI KAISHA, Sakai City, Osaka (JP)

(72) Inventors: TOMOYUKI YAMAMOTO, Sakai City, Osaka (JP); KYOHEI IKEDA, Sakai City, Osaka (JP)

(21) Appl. No.: 16/637,045

(22) PCT Filed: Aug. 2, 2018
(86) PCT No.: PCT/JP2018/029048

§ 371 Date: Feb. 6, 2020

(30) Foreign Application Priority Data
Aug. 9, 2017 (JP) 2017-154551

(51) Int. Cl. G06T 15/20

(52) U.S. Cl. CPC G06T 15/205

(57) ABSTRACT

An image processing device (2, 11, 21, 31) includes: an acquisition unit (4) configured to acquire multiple pieces of partial 3D model data that partially indicate a three-dimensional shape of a display target, the multiple pieces of partial 3D model data being associated with an order in a prescribed sequence; and a generation unit (6) configured to update the reference model with reference to the multiple pieces of partial 3D model data according to the order associated with the multiple pieces of partial 3D model data.

### TECHNICAL FIELD

An aspect of the present invention relates primarily to an image processing device that generates an image indicating a display target from a rendering viewpoint.

### BACKGROUND ART

Generally, examples of systems for achieving video services capable of selecting a rendering viewpoint (a viewpoint in rendering of a video) include systems utilizing images and depths. For example, specific examples of the systems include Depth Image-based Rendering (DIBR).

DIBR will be described below. First, image data indicating a display target from a specific viewpoint and a depth from the viewpoint to the display target are received. The viewpoint of the depth received is then converted in response to a rendering viewpoint to generate a rendering viewpoint depth. Next, a rendering viewpoint image is generated based on the rendering viewpoint, the generated rendering viewpoint depth, and the received image data.

PTL 1 is a document illustrating an example of DIBR having the above configuration.

### CITATION LIST

### Patent Literature

PTL 1: JP 2015-87851 A (published on May 7, 2015)

### SUMMARY OF INVENTION

### Technical Problem

In DIBR described above, a reproduction image of a specified rendering viewpoint is generated based on received data (video+depth) and is presented. However, due to restrictions of the band, there is a problem in that the quality of the generated image is low because 3D model data (information indicating a three-dimensional shape of a display target) such as a depth of the display target that can be received at each time is limited in terms of the number of samples or in terms of the accuracy of noise or holes, and the like.

The present invention has been made in view of the problem described above, and an object of the present invention is to provide a technique that can prevent deterioration in quality of a rendering viewpoint image due to the number of samples or the accuracy of 3D model data, and generate a high-quality rendering viewpoint image in an image processing device that generates a rendering viewpoint image, based on image data and 3D model data.

### Solution to Problem

In order to solve the above-described problem, an image processing device according to an aspect of the present invention includes: an acquisition unit configured to acquire multiple pieces of partial 3D model data that partially indicate a three-dimensional shape of a display target, the multiple pieces of partial 3D model data being associated with an order in a prescribed sequence; a first generation unit configured to generate a reference model with reference to the multiple pieces of partial 3D model data; and a second generation unit configured to generate a rendering viewpoint image representing the display target from a rendering viewpoint with reference to the reference model, wherein the first generation unit updates the reference model with reference to the multiple pieces of partial 3D model data in the order associated with the multiple pieces of partial 3D model data.

In order to solve the above-described problem, an image processing device according to an aspect of the present invention includes: an acquisition unit configured to acquire image data of a display target and multiple pieces of partial 3D model data that partially indicate a three-dimensional shape of the display target, the multiple pieces of partial 3D model data being associated with an order in a prescribed sequence; a first generation unit configured to generate a reference model with reference to the multiple pieces of partial 3D model data; a second generation unit configured to generate a rendering viewpoint image representing the display target from a rendering viewpoint with reference to the image data and the multiple pieces of partial 3D model data; and a correction unit configured to perform image complementation or filtering on the rendering viewpoint image with reference to the reference model, wherein the first generation unit updates the reference model with reference to the multiple pieces of partial 3D model data according to the order associated with the multiple pieces of partial 3D model data.

In order to solve the above-described problem, an image processing device according to an aspect of the present invention includes: an acquisition unit configured to acquire image data of a display target; an estimation unit configured to estimate multiple pieces of partial 3D model data that partially indicate a three-dimensional shape of the display target with reference to the image data; a first generation unit configured to generate a reference model with reference to the multiple pieces of partial 3D model data; and a second generation unit configured to generate a rendering viewpoint image representing the display target from a rendering viewpoint with reference to the image data and the reference model, wherein the first generation unit updates the reference model with reference to the multiple pieces of partial 3D model data, each time the estimation unit estimates each of the multiple pieces of partial 3D model data.

In order to solve the above-described problem, an image transmission device according to an aspect of the present invention includes a transmitter configured to transmit multiple pieces of partial 3D model data that partially indicate a three-dimensional shape of a display target, the multiple pieces of partial 3D model data being associated with an order in a prescribed sequence.

In order to solve the above-described problem, an image processing method according to an aspect of the present invention includes the steps of: acquiring multiple pieces of partial 3D model data that partially indicate a three-dimensional shape of a display target, the multiple pieces of partial 3D model data being associated with an order in a prescribed sequence; generating a reference model with reference to the multiple pieces of partial 3D model data; and generating a rendering viewpoint image representing the display target from a rendering viewpoint with reference to the reference model, wherein the step of generating the reference model updates the reference model with reference to the multiple pieces of partial 3D model data according to the order associated with the multiple pieces of partial 3D model data.

### Advantageous Effects of Invention

According to an aspect of the present invention, in an image processing device that generates a rendering viewpoint image, based on image data and 3D model data, deterioration in quality of a rendering viewpoint image due to the number of samples or the accuracy of 3D model data can be prevented, and a high-quality rendering viewpoint image can be generated.

### BRIEF DESCRIPTION OF DRAWINGS

FIG. 1 is a diagram illustrating an example of partial 3D model data used in each embodiment of the present invention.

FIG. 2 is a block diagram illustrating a configuration of a display device including an image processing device according to Embodiment 1 of the present invention.

FIG. 3 is a flowchart for illustrating an example of an image processing method by the image processing device according to Embodiment 1 of the present invention.

FIG. 4 is a block diagram illustrating a configuration of a display device including an image processing device according to Embodiment 2 of the present invention.

FIG. 5 is a flowchart for illustrating an example of an image processing method by the image processing device according to Embodiment 2 of the present invention.

FIG. 6 is a diagram for illustrating a warp field used in each embodiment of the present invention.

FIG. 7 is a diagram for illustrating example of viewpoint information used in each embodiment of the present invention.

FIGS. 8(a) to 8(d) are diagrams each of which illustrates an example of a data configuration of depth and viewpoint information used in each embodiment of the present invention.

FIG. 9 is a diagram for illustrating a first example of a configuration in which the image processing device according to Embodiment 2 of the present invention preferentially acquires a specific depth of multiple depths.

FIG. 10 is a diagram for illustrating a second example of a configuration in which the image processing device according to Embodiment 2 of the present invention preferentially acquires a specific depth of multiple depths.

FIG. 11 is a diagram for illustrating a third example of a configuration in which the image processing device according to Embodiment 2 of the present invention preferentially acquires a specific depth of multiple depths.

FIG. 12 is a flowchart for illustrating an overview of an image processing method by an image processing device according to Embodiment 3 of the present invention.

FIG. 13 is a flowchart specifically illustrating model initialization performed by the image processing device according to Embodiment 3 of the present invention.

FIG. 14 is a block diagram illustrating a configuration of a display device including an image processing device according to Embodiment 4 of the present invention.

FIG. 15 is a block diagram illustrating a configuration of a display device including an image processing device according to Embodiment 5 of the present invention.

FIG. 16 is a block diagram illustrating a configuration of an image transmission and/or reception system including a display device and an image transmission device according to each embodiment of the present invention.

### DESCRIPTION OF EMBODIMENTS

Embodiments of the present invention will be described below in detail. It should be noted that each configuration described in the present embodiments is not intended to exclusively limit the scope of this invention thereto as long as there is no specific description in particular, and is merely an example for description.

First, definitions of terms used in each embodiment of the present invention will be described below. The term “image data” in the present specification indicates an image (color information of each pixel, and the like) indicating a display target from a particular viewpoint. Note that the image in the present specification includes a still image and a video.

The term “partial 3D model data” in the present specification refers to data that partially indicates a three-dimensional shape of a display target. Examples of the “partial 3D model data” include depths from a particular viewpoint, point clouds (a subset of point groups), and meshes (a subset of mesh data that indicates vertices, connections, surfaces, etc.), and the like. In addition, data convertible to depth data, point cloud or mesh is also included in the partial 3D model data. For example, since depth data can be extracted by stereo matching from a set of image data that has captured the same target from different positions, the set of image data is also included in the partial 3D model data. For example, since depth data can be extracted from a set of image data that has captured the target at different focal distances from the same position, the set of image data is also included in the partial 3D model data.

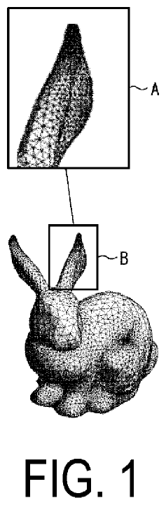

FIG. 1 is a diagram illustrating an example of partial 3D model data. The 3D model data (mesh) illustrated in FIG. 1 is an example in which the portion of the display target surrounded by the thick frame B is partial 3D model data, and the diagram surrounded by the thick frame A is an enlarged view of the partial 3D model data.

The term “reference model” in the present specification refers to a 3D model that represents a part or the whole of a display target created by integrating partial 3D model data.

The term “reproduction depth” in the present specification refers to a depth from a rendering viewpoint to each portion of the display target.

### Embodiment 1

### Image Processing Device 2

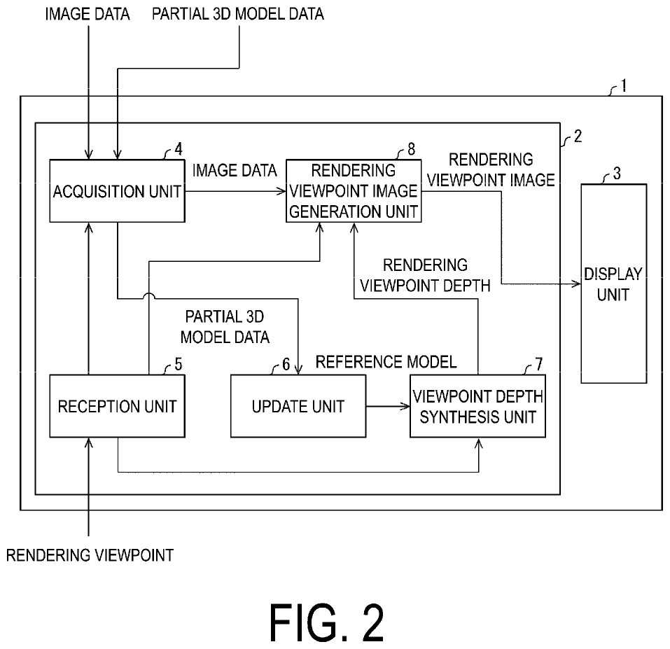

An image processing device 2 according to the present embodiment will be described in detail with reference to FIG. 2. FIG. 2 is a block diagram illustrating a configuration of a display device 1 according to the present embodiment. As illustrated in FIG. 2, the display device 1 includes an image processing device 2, and a display unit 3. The image processing device 2 includes an acquisition unit 4, a reception unit 5, and an update unit 6 (corresponding to a generation unit in the claims), a viewpoint depth generation unit 7, and a rendering viewpoint image generation unit 8.

The acquisition unit 4 acquires image data of a display target and multiple partial 3D model data that partially indicate a three-dimensional shape of the display target. With regard to the acquisition of the multiple partial 3D model data, more specifically, the acquisition unit 4 acquires multiple partial 3D model data associated with an order in a prescribed sequence. With respect to this configuration, for example, the acquisition unit 4 acquires multiple partial 3D model data associated with different time in an order corresponding to the time. Note that the “time” will be described later.

The reception unit 5 receives a rendering viewpoint (information related to the rendering viewpoint) from the outside of the image processing device 2.

The update unit 6 updates a reference model with reference to the partial 3D model data acquired by the acquisition unit 4. More specifically, the update unit 6 updates the reference model with reference to the partial 3D model data in the above-described order associated with the partial 3D model data acquired by the acquisition unit 4.

The viewpoint depth generation unit 7 generates a reproduction depth, which is a depth from the rendering viewpoint to each portion of the display target, with reference to the rendering viewpoint received by the reception unit 5 and the reference model updated by the update unit 6.

The rendering viewpoint image generation unit 8 generates a rendering viewpoint image representing the display target from the rendering viewpoint, with reference to the rendering viewpoint received by the reception unit 5, the image data acquired by the acquisition unit 4, and the reproduction depth generated by the viewpoint depth generation unit 7.

The display unit 3 displays the rendering viewpoint image generated by the rendering viewpoint image generation unit 8. Examples of the display unit 3 include a head-mounted display and the like.

### Image Processing Method

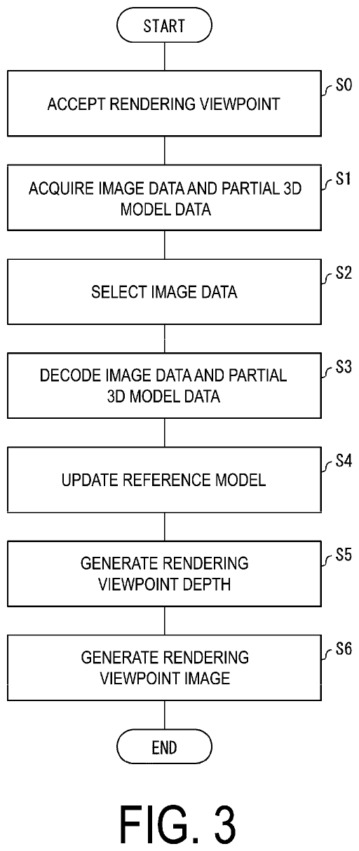

An image processing method by the image processing device 2 according to the present embodiment will be described with reference to FIG. 3. FIG. 3 is a flowchart for illustrating an example of the image processing method by the image processing device 2 according to the present embodiment.

First, as illustrated in FIG. 3, the reception unit 5 receives a rendering viewpoint (information related to the rendering viewpoint) from the outside of the image processing device 2 (step S0). The reception unit 5 transmits the received rendering viewpoint to the acquisition unit 4, the viewpoint depth generation unit 7, and the rendering viewpoint image generation unit 8. Note that the rendering viewpoint received by the reception unit 5 may be a rendering viewpoint configured by a user of the display device 1, or may be a rendering viewpoint specified by the display device 1.

Next, the acquisition unit 4 acquires image data of a display target and partial 3D model data that partially indicates a three-dimensional shape of the display target (step S1). The multiple partial 3D model data acquired by the acquisition unit 4 (single or a few 3D model data) are associated with time. Note that the multiple partial 3D model data here are preferably data indicating different portions of the display target. The time associated with the partial 3D model data is, for example, a display time at which the image indicated by the depth data is to be displayed. The partial 3D model data is not necessarily associated with time, but may be associated with an order in a prescribed sequence (for example, display order).

Next, the acquisition unit 4 selects the image data to be decoded in the acquired image data in accordance with the rendering viewpoint received by the reception unit 5 (step S2). Note that instead of step S2, in step S1, the acquisition unit 4 may select and acquire image data in accordance with the rendering viewpoint received by the reception unit 5.

Next, the acquisition unit 4 decodes the selected image data and the acquired partial 3D model data (step S3). Then, the acquisition unit 4 transmits the decoded image data to the rendering viewpoint image generation unit 8, and transmits the decoded partial 3D model data to the update unit 6.

Next, the update unit 6 updates a reference model with reference to the partial 3D model data in accordance with the time (order in the prescribed sequence) associated with the partial 3D model data received from the acquisition unit 4 (step S4). Preferably in step S4, the update unit 6 updates the reference model with reference to the partial 3D model data, each time the update unit 6 receives the partial 3D model data from the acquisition unit 4 (in other words, each time the acquisition unit 4 acquires the partial 3D model data). Then, the update unit 6 transmits the updated reference model to the viewpoint depth generation unit 7. Note that in a case that the reference model has not yet been generated in a case of performing the step of step S4, the update unit 6 may transmit the partial 3D model data received from the acquisition unit 4 as a reference model to the viewpoint depth generation unit 7.

Next, the viewpoint depth generation unit 7 generates a reproduction depth, which is a depth from the rendering viewpoint to each portion of the display target, with reference to the rendering viewpoint received from the reception unit 5 and the reference model updated by the update unit 6 (step S5). Then, the viewpoint depth generation unit 7 transmits the generated reproduction depth to the rendering viewpoint image generation unit 8.

Next, the rendering viewpoint image generation unit 8 generates a rendering viewpoint image representing the display target from the rendering viewpoint, with reference to the rendering viewpoint received from the reception unit 5, the image data received from the acquisition unit 4, and the reproduction depth received from the viewpoint depth generation unit 7 (step S6). Then, the rendering viewpoint image generation unit 8 transmits the generated rendering viewpoint image to the display unit 3. The display unit 3 displays the rendering viewpoint image received from the rendering viewpoint image generation unit.

Note that, by the steps from step S0 to step S6 above, each frame of the rendering viewpoint image is generated. Then, the steps from step S0 to step S6 are repeated until the reproduction of the video by the display device 1 has ended.

### Preferentially Acquired Partial 3D Model Data

Hereinafter, the data acquired by the acquisition unit 4 preferentially among the multiple partial 3D model data in step S1 will be described.

For example, in a case that the acquisition unit 4 acquires the partial 3D model data in any order, there is a problem in that the information required for the generation of the rendering viewpoint video (and the information required for the generation of the reference model) may not be successfully collected in some order depending on the rendering viewpoint applied. Thus, the acquisition unit 4 preferably acquires the partial 3D model data in the sequence illustrated below or a combination thereof. Note that the configuration described in this section may be achieved by the acquisition unit 4 requesting the partial 3D model data necessary for the image transmission device 41 described later, or may be achieved by sequentially transmitting the necessary partial 3D model data by the image transmission device 41.

(1) Prioritize Portion Associated with Rendering Viewpoint

Example 1: The acquisition unit 4 preferentially acquires, in step S1, the partial 3D model data indicating the portion of the display target relative to the rendering viewpoint received by the reception unit 5 in step S0.

Example 2: The acquisition unit 4 preferentially acquires, in step S1, the partial 3D model data indicating the portion of the display target relative to the initial viewpoint of the rendering viewpoint received by the reception unit 5 in step S0 (the viewpoint of the rendering viewpoint image at the reproduction start).

Example 3: The acquisition unit 4 preferentially acquires, in step S1, the partial 3D model data indicating the portion of the display target relative to the prescribed viewpoint in step S0. Note that the prescribed viewpoint here (so-called predefined standard viewpoint or recommended viewpoint) may be configured by a user of the display device 1, or may be configured by the display device 1.

Note that in the above-described example, the partial 3D model data relative to the specific viewpoint indicates partial 3D model data including a portion of a 3D model observable from the specific viewpoint. Preferentially acquiring the partial 3D model data relative to the specific viewpoint means, for example, acquiring the partial 3D model data relative to the specific viewpoint earlier than partial 3D model data that is not relative to the specific viewpoint. Alternatively, preferentially acquiring the partial 3D model data relative to the specific viewpoint means, for example, receiving the partial 3D model data relative to the specific viewpoint more than partial 3D model data that is not relative to the specific viewpoint, within a prescribed time interval.

By adopting at least one or more configurations of the configuration of Example 1 to Example 3, the partial 3D model data necessary for the generation of the rendering viewpoint video can be prepared as appropriate.

### (2) Prioritize Rough Partial 3D Model Data

Example 1: The acquisition unit 4 preferentially acquires partial 3D model data corresponding to a wider portion of the display target and including vertex information decimated at a prescribed interval.

By employing the configuration of Example 1, even in a situation where the amount of information of the partial 3D model data obtainable is limited by the restriction of the band, even in a case that movement of the rendering viewpoint occurs frequently, the image quality of the rendering viewpoint image can be suppressed from deteriorating significantly due to absence of the partial 3D model data corresponding to the portion of the display target necessary for the rendering viewpoint image generation.

### Specific Example of Reference Model Update Processing

Hereinafter, a specific example of how the update unit 6 updates the reference model in step S4 will be described. First, a specific example of the partial 3D model data referenced in a case that the update unit 6 updates the reference model in step S4 will be described.

For example, the partial 3D model data includes information indicating a positional relationship (relative position) between the reference model and the partial 3D model data. The information is expressed by the following Equation (1).

O₁={xₒ₁, yₒ₁, zₒ₁}, O₂={xₒ₂, Yₒ₂, zₒ₂} Equation (1)

O₁ and O₂ represent two points in a space including the reference model, and the range of the cuboid determined by the two points indicates the arrangement of the partial 3D model data for the reference model.

For example, the partial 3D model data includes information about how to update the reference model. The information indicates the type of update method, and examples of the type include an update method by adding partial 3D model data to the reference model, and an update method by replacing part of the reference model with partial 3D model data, and the like.

For example, the partial 3D model data includes information indicating the three-dimensional shape of the partial 3D model illustrated in Equation (2) to Equation (4) below.

Vₛ={Vₛ₁, Vₛ₂, . . . } Equation (2)

Eₛ={Eₛ₁, Eₛ₂, . . . } Equation (3)

Eₛₙ={Iₙ₁, Iₙ₂, Iₙ₃} Equation (4)

Vₛ indicates the vertex information (a set of vertices) of the partial 3D model. Eₛ indicates the vertex connection information (a set of triangles) connecting adjacent vertices of the partial 3D model. Eₛₙ indicates an index specifying each vertex of these triangles.

Next, a specific example of how the update unit 6 updates the reference model in step S4 will be described. For example, the reference model includes information indicating the three-dimensional shape of the reference model. Examples of such information include vertex information Vᵣ, vertex connection information Eᵣ, and the like.

Next, a specific example of step S4 using the above-described partial 3D model data and reference model will be described. For example, in step S4, the update unit 6 sequentially performs (1) to (4) below. (1) The update unit 6 configures the range of the reference model corresponding to the range indicated by the information O₁ and O₂ indicating the relative position of the reference model and the partial 3D model data described above as the range of the processing target.

(2) In a case that the information indicating the type of update method described above is “substitution”, the update unit 6 removes the vertex information and the vertex connection information of the range of the processing target configured in (1).

(3) The update unit 6 adds the vertex information Vₛ and the vertex connection information Eₛ included in the partial 3D model data to the reference model. Thus, the vertex information Vᵣ and the vertex connection information Eᵣ of the reference model are illustrated in the union of Equation (5) and Equation (6) below.

Vᵣ=VᵣU Vₛ′ Equation (5)

Eᵣ=EᵣU Eₛ′ Equation (6)

Note that Vₛ′ in Equation (5) above is a set of points at which variation O₁ is added to each vertex of Vₛ. The vertex index of Eₛ′ in Equation (6) above is the vertex index of Eₛ updated to the vertex index at updated Vᵣ.

(4) In the reference model after processing (3), the update unit 6 scans the vertices near the boundary of the range of the processing target, connects the vertices adjacent to each other and unconnected yet, and adds the connection information to Eᵣ.

Note that the updating method of the reference model described above is an example, and another method of modifying the contents of the reference model data may be used based on the partial 3D model data.

### Summary of Embodiment 1

As described above, the image processing device 2 according to the present embodiment acquires multiple partial 3D model data that partially indicate a three-dimensional shape of a display target, the multiple partial 3D model data being associated with an order in a prescribed sequence, and updates the reference model with reference to the partial 3D model data in the order associated with the partial 3D model data. Then, the image processing device 2 generates a rendering viewpoint image representing the display target from the rendering viewpoint with reference to the image data and the updated reference model.

The depth utilized in DIBR described in Background Art described above contains only 3D information indicating a display target from a specific viewpoint, and is not suitable for the realization of a service such as looking around the display target. However, in the image processing device 2 according to the present embodiment, the rendering viewpoint image from various viewpoints can be preferably generated by generating the rendering viewpoint image with reference to the reference model generated by the multiple partial 3D model data that partially indicate the three-dimensional shape of the display target.

The image processing device 2 according to the present embodiment acquires the multiple partial 3D model data that partially indicate the three-dimensional shape of the display target. Thus, the amount of data of the 3D model data acquired can be reduced compared to a case where the 3D model data indicating the entire three-dimensional shape of the display target is received at each time point.

The image processing device 2 according to the present embodiment updates the reference model with reference to the partial 3D model data in the order associated with the partial 3D model data. This configuration prevents deterioration in quality of the rendering viewpoint image due to the number of samples or the accuracy of the 3D model data resulting from configurations that generate a rendering viewpoint image using a single 3D model data as in the related art, and a high-quality rendering viewpoint image can be generated.

### Embodiment 2

As described in Embodiment 1, in a case that a configuration is employed in which a specific partial 3D model data is preferentially acquired in accordance with the rendering viewpoint, the state of the updated reference model depends on the selection results of the past rendering viewpoint. Therefore, in a case that the history of the past rendering viewpoint is different, there is a problem in that the variation of the reproduction results of the video at the same time and in the same viewpoint will be large, and the assurance of the reproduction results becomes difficult. Thus, the image processing device 11 according to the present embodiment acquires multiple partial 3D model data without depending on the rendering viewpoint.

Embodiment 2 of the present invention as described above will be described below with reference to the drawings. Note that members having the same function as the members included in the image processing device 2 described in Embodiment 1 are denoted by the same reference signs, and descriptions thereof will be omitted.

### Image Processing Device 11

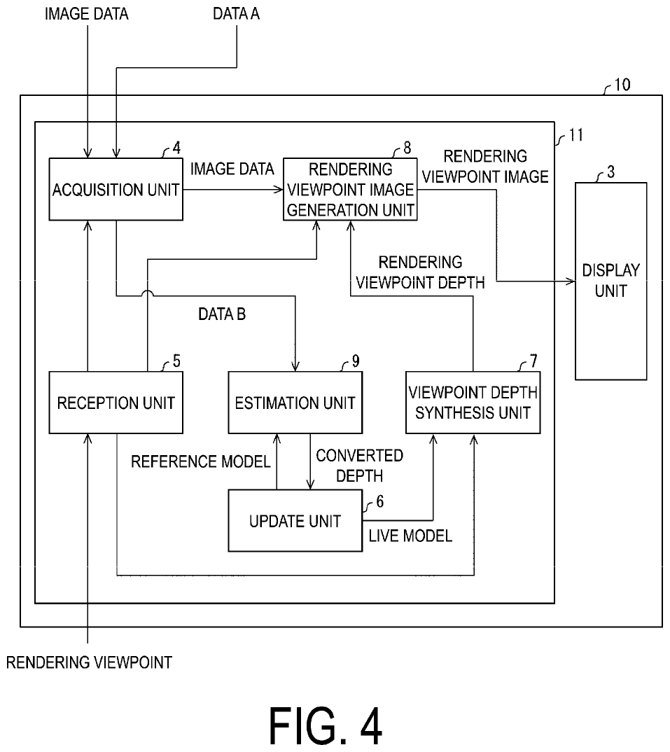

An image processing device 11 according to the present embodiment will be described with reference to FIG. 4. FIG. 4 is a block diagram illustrating a configuration of a display device 10 according to the present embodiment. As illustrated in FIG. 4, the display device 10 has the same configuration as the display device 1 according to Embodiment 1, except that the image processing device 11 further includes an estimation unit 9 (corresponding to a generation unit in the claims). Note that in the present embodiment, the data A and the data B illustrated in FIG. 4 are depth (depth data) that partially indicates the three-dimensional shape of the display target, and the viewpoint information related to the viewpoint of the depth.

With reference to the depth and the viewpoint information acquired by the acquisition unit 4 and the reference model updated immediately before by the update unit 6, the estimation unit 9 estimates a warp field indicating a positional relationship between the reference model and the 3D model (live model) at a time point corresponding to the depth. Note that the warp field in this case will be described later.

### Image Processing Method

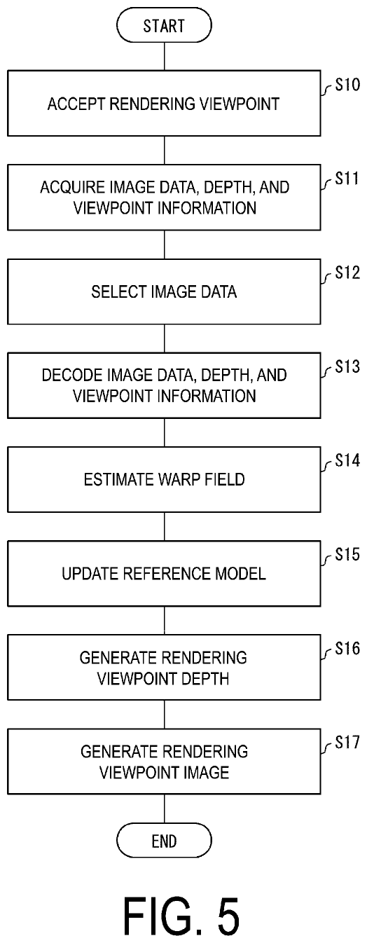

An image processing method by the image processing device 11 according to the present embodiment will be described in detail with reference to FIG. 5. FIG. 5 is a flowchart for illustrating an example of the image processing method by the image processing device 11 according to the present embodiment. Note that the same steps as the image processing method according to Embodiment 1 are omitted from the detailed description.

First, as illustrated in FIG. 5, the reception unit 5 receives a rendering viewpoint (information related to the rendering viewpoint) from the outside of the image processing device 11 (step S10). The reception unit 5 transmits the received rendering viewpoint to the acquisition unit 4, the viewpoint depth generation unit 7, and the rendering viewpoint image generation unit 8.

Next, the acquisition unit 4 acquires image data of the display target, a depth (depth associated with the order in the prescribed sequence) that partially indicates the three-dimensional shape of the display target, and information related to the viewpoint of the depth (viewpoint information) (step S11). With respect to the acquisition of the depth and the viewpoint information, more specifically, the acquisition unit 4 acquires the depth (partial 3D model data) and the viewpoint information without depending on the rendering viewpoint received by the reception unit 5 at step S10.

Next, the acquisition unit 4 selects the image data to be decoded in the acquired image data in accordance with the rendering viewpoint received by the reception unit 5 (step S12).

Next, the acquisition unit 4 decodes the selected image data and the acquired depth and viewpoint information (step S13). Then, the acquisition unit 4 transmits the decoded image data to the rendering viewpoint image generation unit 8, and transmits the decoded depth and viewpoint information to the estimation unit 9.

Next, the estimation unit 9 references the depth and viewpoint information, and the reference model updated immediately before by the update unit 6, in the order associated with the depth received from the acquisition unit 4, and estimates a warp field indicating a positional relationship between the reference model and the 3D model (live model) at a time point corresponding to the depth (step S14). Note that the warp field in this case will be described later.

Next, the update unit 6 updates the reference model with reference to the warp field estimated by the estimation unit 9 (step S15). More specifically, the update unit 6 updates the reference model by converting the depth, based on the warp field. The reference model is updated such that the converted depth is part of the surface of the reference model.

Next, the viewpoint depth generation unit 7 generates a rendering viewpoint depth, which is a depth from the rendering viewpoint to each portion of the display target, with reference to the rendering viewpoint received from the reception unit 5 and the live model generated by the update unit 6 (step S16). Then, the viewpoint depth generation unit 7 transmits the generated rendering viewpoint depth to the rendering viewpoint image generation unit 8.

Next, the rendering viewpoint image generation unit 8 generates a rendering viewpoint image representing the display target from the rendering viewpoint, with reference to the rendering viewpoint received from the reception unit 5, the image data received from the acquisition unit 4, and the rendering viewpoint depth received from the viewpoint depth generation unit 7 (step S17). Then, the rendering viewpoint image generation unit 8 transmits the generated rendering viewpoint image to the display unit 3. The display unit 3 displays the rendering viewpoint image received from the rendering viewpoint image generation unit.

### Warp Field

The warp field used in step S14 and step S15 described above will be described in detail below. In the fields of CG, an approach called DynamicFusion, which constructs a 3D model by integrating depths, is studied. The purpose of DynamicFusion is to construct a 3D model where noise is canceled in real time from the captured depth. In DynamicFusion, the depth acquired from the sensor is integrated into a common reference model after compensation for 3D shape deformations. This allows for the generation of precise 3D models from low resolution and high noise depths.

More specifically, in DynamicFusion, the following steps (1) to (3) are performed.

(1) Estimate a camera position and motion flow, based on an input depth (current depth) and a reference 3D model (canonical model), to construct a 3D model (current model).

(2) Render the 3D model depending on the viewpoint and output the updated depth as the reproduction depth.

(3) Integrate the 3D model constructed in (1) into the reference 3D model after compensation for the camera position of the 3D model and deformation of the 3D model.

With respect to (1) above, in the image processing method according to the present embodiment, at step S14, with reference to the depth (input depth) and the viewpoint information received from the acquisition unit 4 and the reference model updated immediately before by the update unit 6, the estimation unit 9 estimates a warp field indicating a positional relationship between the reference model and the 3D model (live model) corresponding to the depth. The warp field in this case may be a set of conversions (for example, rotation and translation) defined at each point in space.

With respect to step S14, more specifically, the estimation unit 9 derives a conversion (warp field) such that the converted point approaches the input depth at each point on the reference model. The deriving processing can be achieved, for example, by solving the minimization of the square error that uses the distance between the converted point and the corresponding depth in the reference model as an evaluation value.

Then, in step S15, the update unit 6 generates a live model (3D model at the current time) by converting the reference model by the warp field derived by the estimation unit 9 in step S14. The update unit 6 updates the reference model with reference to the depth and the warp field. For example, the reference model here is expressed as the establishment of presence of the model surface in each voxel in space (represented by Truncated Signed Distance Function (TSDF)).

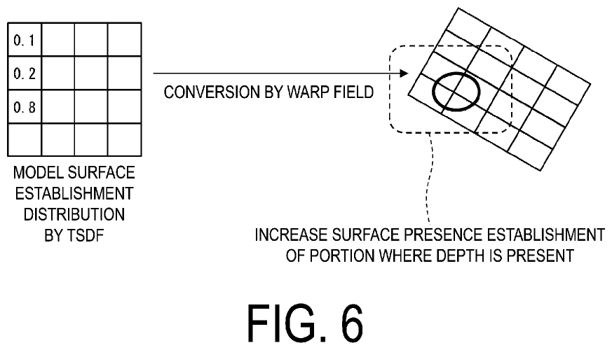

FIG. 6 is a diagrammatic representation of step S15. With respect to step S15, more particularly, the update unit 6 converts the voxels by a warp field, determine whether there is a point represented by the input depth in the voxels after conversion, and updates the probability of presence of the surface in the voxels in accordance with the determination result.

### Specific Example of Depth and Viewpoint Information

A Specific example of the depth and the viewpoint information acquired by the acquisition unit 4 in step S11 described above will be described in detail below.

The depth (depth data) acquired by the acquisition unit 4 in step S11 is an image that records the depth of a scene (display target) from the viewpoint position associated with the viewpoint information. The viewpoint information is information identifying the position and direction of the viewpoint (depth viewpoint) of the depth. By using this viewpoint information by the image processing device 11 according to the present embodiment, the estimation process of the depth viewpoint can be omitted, so the load during reproduction can be reduced.

The viewpoint information will be described in more detail. In one aspect, the viewpoint information is represented by coordinates or displacements of the depth viewpoint. For example, the viewpoint information includes the position of the depth viewpoint at each time in the data. Alternatively, the viewpoint information includes the displacement of the depth viewpoint of each time from the prescribed viewpoint position in the data. The prescribed viewpoint position can be, for example, a viewpoint position of the immediately preceding time or a predefined viewpoint position.

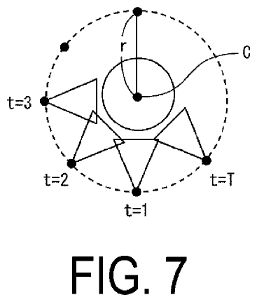

In another aspect, the viewpoint information is represented by parameters or functions. For example, the viewpoint information includes information in the data identifying a conversion equation that represents a relationship between the time and the position of the depth viewpoint. Examples of the information include information identifying the center position of the display target and the orbit trajectory of the depth viewpoint at each time. FIG. 7 is a diagrammatic representation of an example of the information. In FIG. 7, the center position of the display target (center position of the sphere) is indicated by the position C, and the depth viewpoint at each time (t) is illustrated at a position on the sphere with a radius r centered at the position C.

Another example of information identifying a conversion equation that represents a relationship between the time and the position of the depth viewpoint include information specifying the trajectory and speed (velocity) of the depth viewpoint. For example, the information may be an equation of the trajectory of the camera position, an equation of the trajectory of the target viewpoint, a camera movement speed, a viewpoint movement speed, or the like.

The information identifying a conversion equation representing a relationship between the time and the position of the depth viewpoint may be information for selecting a predefined position pattern at each time.

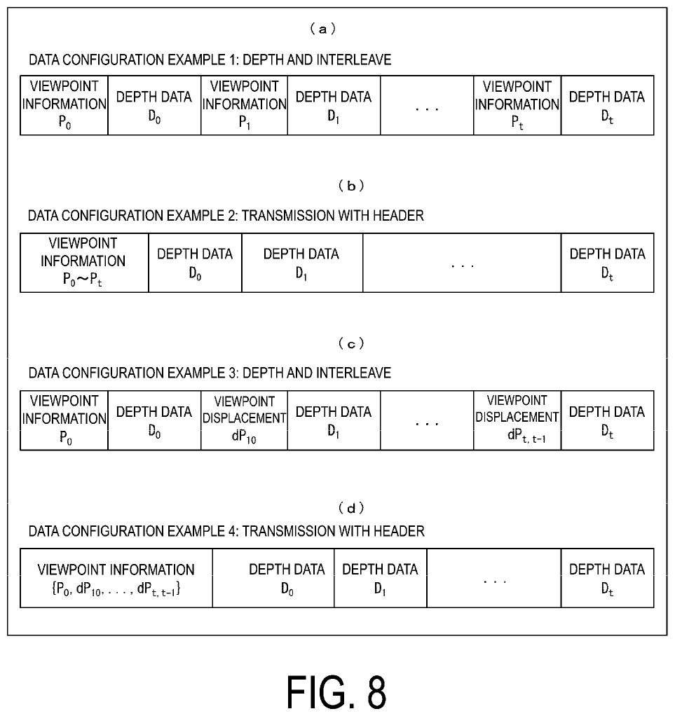

Next, a data configuration of the depth and the viewpoint information acquired by the acquisition unit 4 in step S11 will be described with reference to FIG. 8. (a) to (d) of FIG. 8 are diagrams each of which illustrates an example of a data configuration of the depth and the viewpoint information acquired by the acquisition unit 4 in step S11.

For example, as illustrated in (a) of FIG. 8, the viewpoint information Pₜ at each time (t) is interleaved (alternately arranged) with the depth data Dₜ at each time. In another example, as illustrated in (b) of FIG. 8, the viewpoint information P from time 0 to time t is stored in the header.

The viewpoint information Pₜ in (a) and (b) of FIG. 8 includes external parameters of the camera at time t. For example, the external parameter may be information indicating a viewpoint position in space (for example, position p={px, py, pz} of a point in xyz space). For example, the external parameter may be information indicating a line of sight direction (example: xyz space vector v=({vx, vy, vz}). The viewpoint information Pₜ in (a) and (b) of FIG. 8 may be data of another expression representing an external parameter of the camera at time t. For example, an example of the data may be data indicating rotation or translation relative to a predefined camera position. The viewpoint information Pₜ may also include an internal parameters of the camera (for example, a camera focal distance) in addition to the external parameters of the camera.

In another example, as illustrated in (c) of FIG. 8, the viewpoint information P₀ at time t=0 and each displacement dP_{t,t-1} from the viewpoint information P₀ are interleaved with the depth data Dₜ at each time. In another example, as illustrated in (d) of FIG. 8, each displacement dP_{t,t-1} from the viewpoint information P₀ is stored in the header.

The viewpoint information in (c) and (d) of FIG. 8 includes a viewpoint position at a specific time and a viewpoint displacement between times (viewpoint displacement dP_{t,u}). The viewpoint displacement dP_{t,u} indicates a change in the camera position and the direction (viewpoint position displacement and line of sight direction displacement) from time u to time t. The viewpoint position displacement here indicates information indicating a change in the viewpoint position in space (example: xyz space vector dp={dpx, dpy, dpz}). The line of sight direction displacement here indicates information indicating a change in the line of sight direction (example: xyz space rotation matrix R).

Using the above viewpoint displacement dP_{t,u} and viewpoint information P₀ at time t=0, the line of sight position Pₜ at each time is determined by the following Equation (7).

Pₜ=p₀+{dp_{k,k-1}} Equation (7)

Using a rotation matrix R_{t,t-1} indicating rotation between times, the line of sight direction Vt at each time is determined by Equation (8) below.

vₜ=R_{t,t-1}vₜ₋₁ Equation (8)

The image processing device 11 according to the present embodiment uses the viewpoint position displacement and line of sight direction displacement as described above as the viewpoint information. As a result, in cases where the coordinate system changes, such as a case that the display target changes, only the initial viewpoint position may be changed, and the viewpoint position displacement can be the same as the viewpoint position displacement before the coordinate system changes, so the effect of requiring a few modifications in the viewpoint information is achieved.

### Preferentially Acquired Depth

Hereinafter, the depth preferentially acquired by the acquisition unit 4 among multiple depths in step S11 will be described.

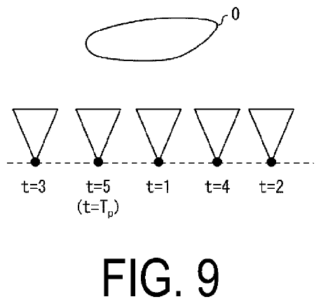

For example, the acquisition unit 4 acquires the depth in the sequence corresponding to the viewpoint of the depth indicated by the viewpoint information as a sequence of depth acquired in the multiple depths. More specifically, the acquisition unit 4 first acquires the depth of the viewpoint of the initial position among the viewpoint positions allocated on a certain line segment (the viewpoint position indicated by the viewpoint information), and then preferentially acquires the depth of the viewpoint position away from the viewpoint of the initial position. FIG. 9 is a diagrammatic representation of the configuration. In FIG. 9, the target O and the viewpoint position of each time (t=1 to 5) allocated on the line segment and relative to the target O are illustrated.

For example, in a case that the depth of the viewpoint of t=1 is acquired as a depth from the viewpoint of the initial position, the acquisition unit 4 acquires the depth of the viewpoint away from the initial position (depth from the viewpoint of t=2 or 3). Next, the acquisition unit 4 acquires the depth of the viewpoint of the intermediate position (depth of the viewpoint of t=4 or 5).

As described above, the acquisition unit 4 acquires the depth in the sequence corresponding to the viewpoint of the depth indicated by the viewpoint information as a sequence of depth acquired in the multiple depths, which achieves the effect that an overview of the model shape of the display target can be constructed in a short time.

For example, in a configuration such as that illustrated in FIG. 9, the acquisition unit 4 may repeatedly acquire the depth of each viewpoint of t=1 to 5 in the sequence described above. In such a case, the acquisition unit 4 further acquires the cycle Tₚ from the acquisition of the depth of t=1 to the acquisition of the depth of t=5 (or depth of t=4), and repeatedly acquires the depth of each viewpoint of t=1 to 5 at the cycle. This procedure provides the effect that an overview of the model shape can be constructed in a short time even in a case that the depth is received from the middle.

For example, in a configuration such as that illustrated in FIG. 9, the acquisition unit 4 may repeatedly acquire the depth of each viewpoint of t=1 to 5, in a case that the interval between the viewpoint of the next acquired depth and the viewpoint of any of the already acquired depths of t=1 to 5 is less than or equal to a prescribed interval (minimum viewpoint interval), after acquiring the depths of the viewpoints of t=4 or 5. In this case, the acquisition unit 4 may further acquire the minimum viewpoint interval described above as data.

Note that, in a configuration such as that illustrated in FIG. 9, the depth of the viewpoint position allocated on the line segment, acquired by the acquisition unit 4, may be a depth of the viewpoint position allocated on a partial curve, a depth of the viewpoint position allocated on a partial plane, a depth of the viewpoint position allocated on a partial curved surface, or a depth of the viewpoint position allocated on a partial space. In such a case, the acquisition unit 4 preferentially acquires the depth of the viewpoint position away from the viewpoint of the initial position among the viewpoint positions (the viewpoint positions indicated by the viewpoint information) allocated on the partial curve, the partial plane, the partial curved surface, or the partial space. The acquisition unit 4 may preferentially acquire the depth of the viewpoint away from the acquired viewpoint group of depths. The acquisition unit 4 may repeatedly acquire the already acquired depth from the depth of the viewpoint of the initial position again in a case of acquiring a depth of the viewpoint position with a distance from a specified number of viewpoint group of depths or each viewpoint of the already acquired depth being less than or equal to the prescribed depth.

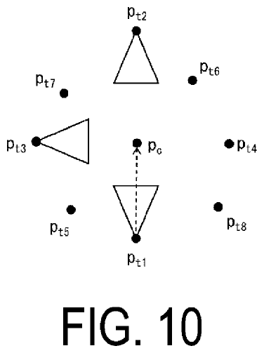

In another aspect, the viewpoint of the depth acquired by the acquisition unit 4 in step S11 is oriented toward a common target point (a point indicating the position of the display target) as the line of sight. In such a case, the acquisition unit 4 acquires information of the target point, and references the information to determine the sequence of the acquired depths. Note that the sequence in which the acquisition unit 4 acquires the depths here is preferably a sequence in which depths in various line of sight directions can be acquired for the target point. FIG. 10 is a diagrammatic representation of the configuration. In FIG. 10, the viewpoints Pₜ₁ to Pₜ₈ is oriented toward the target point P_{c} as a line of sight, respectively.

In a configuration as illustrated in FIG. 10, first, the acquisition unit 4 acquires the position P_{c} of the target point. Next, the acquisition unit 4 acquires the depth of the viewpoint position of Pₜ₁ (the viewpoint position at time t=1). Next, the acquisition unit 4 acquires the depth of Pₜ₂ that is oriented to the line of sight direction most different from the line of sight direction of the acquired depth (depth of Pₜ₁). Then, the acquisition unit 4 repeatedly performs the step of acquiring the depth of the viewpoint that is oriented toward the line of sight direction most different from the line of sight direction of the acquired depth. The acquisition unit 4 may repeatedly perform the step until a difference between the line of sight of the acquired depth and the line of sight of a prescribed number of depths or the line of sight of the acquired depth becomes less than or equal to a prescribed value.

The acquisition unit 4 may further acquire information of depth viewpoint configurable range in step S11, and acquire depth and viewpoint information under constraints such as within the range indicated by the information.

In step S11, the acquisition unit 4 may acquire information indicating the shape of the display target, along with the information of the target point (such as the position of the target point). Examples of the information include information indicating a spherical or rectangular shape centered at the target point, information indicating a 3D model in which the target point is a reference position, and the like. In a case that the acquisition unit 4 acquires information indicating the shape of the display target, the depth of each viewpoint may be acquired in order such that the surface of the display target is covered with a fewer number of viewpoints.

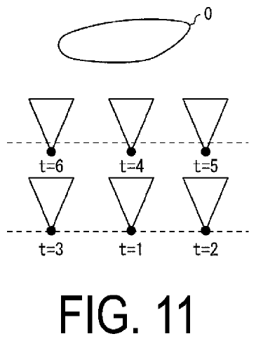

In step S11, the acquisition unit 4 may preferentially acquire the depth of the viewpoint of a distance farther away from the display target. In such a case, in step S11, the acquisition unit 4 acquires the depth of the viewpoint that is closer to the display target than the viewpoint of the depth acquired previously. FIG. 11 is a diagrammatic representation of the configuration. In FIG. 11, each viewpoint at time t=1 to 6 is oriented toward the display target O as the line of sight direction. In step S11, first, the acquisition unit 4 preferentially acquires the depth of viewpoint (depth of viewpoint of t=1 to 3) of the position farthest from the display target. Next, the acquisition unit 4 acquires the depth of the viewpoint that is closer to the display target (depth of the viewpoint of t=4 to 6) than the viewpoint of the already acquired depth. Depths of a wider space are included in a case of viewpoint away from the display target, and hence adopting the configuration as described above allows, by acquiring the depths first, construction of the schematic shape of the reference model with a fewer number of depths. The shape of the reference model can be more precisely updated by thereafter acquiring a depth of high spatial resolution (depth closer to the display target).

### Modifications

Modifications according to the present embodiment will be described below. In the present modification, the image processing device 11 illustrated in FIG. 4 is used, but the data A and the data B in FIG. 4 are only depths and do not include information related to the viewpoint of depth (viewpoint information). In the configuration, in the above-described step S14, in addition to estimating the warp field, the estimation unit 9 further estimates the viewpoint information of the depth with reference to the depth received from the acquisition unit 4. This allows each step after step S14 to be performed in the manner described above.

By adopting the configuration described above, the amount of processing of the warp field estimation increases, but the amount of data can be reduced because the viewpoint information need not be acquired.

### Summary of Embodiment 2

As described above, the image processing device 11 according to the present embodiment acquires the multiple partial 3D model data without depending on the rendering viewpoint. In this way, by generating the reference model by the partial 3D model data that does not depend on the rendering viewpoint, even in a case that the history of the past rendering viewpoint is different, the effect is achieved that the reproduction results of the video at the same time and in the same viewpoint will be the same in a case that the same partial 3D model data is acquired.

The image processing device 11 according to the present embodiment references the depth and reference model in the order associated with the depth to estimate a warp field indicating a positional relationship between the reference model and the reference model corresponding to the depth, and updates the reference model with reference to the warp field. This allows for the construction of a reference model in which noise is canceled in real time from the depth in a configuration in which the depth is used as the partial 3D model data, and thus, a high-quality rendering viewpoint image can be generated.

The image processing device 11 according to the present embodiment acquires the viewpoint information related to the viewpoint of the depth along with the depth. This allows the depth to be selected and acquired depending on the viewpoint of depth indicated by the viewpoint information, and thus the depth required for the construction of the reference model in accordance with the rendering viewpoint can be preferentially acquired. Thus, a high-quality rendering viewpoint image can be generated.

### Embodiment 3

In Embodiment 1 or Embodiment 2 described above, the acquisition unit 4 acquires the multiple partial 3D model data (depth and the like) at different times, and thus there is a problem that the generated reference model is incomplete and the image quality of the finally generated rendering viewpoint image deteriorates because the required partial 3D model data is not successfully collected after the start of receiving the partial 3D model data until a certain time passes. Thus, in this embodiment, an initial reference model is generated by acquiring multiple partial 3D model data for an initial reference model construction at the start of the process and referencing to the multiple partial 3D model data for the initial reference model construction. For example, prior to displaying the rendering viewpoint image, a portion of the multiple partial 3D model data is acquired as data for the initial reference model construction necessity and the initial reference model is generated with reference to the multiple partial 3D model data.

Embodiment 3 of the present invention will be described below with reference to the drawings. Note that the image processing device 2 according to Embodiment 1 or the image processing device 11 according to Embodiment 2 described above can also be used in the present embodiment. Therefore, in the following description, the display device 10 provided with the image processing device 11 illustrated in FIG. 4 will be used, and descriptions of each member provided by the display device 10 will be omitted.

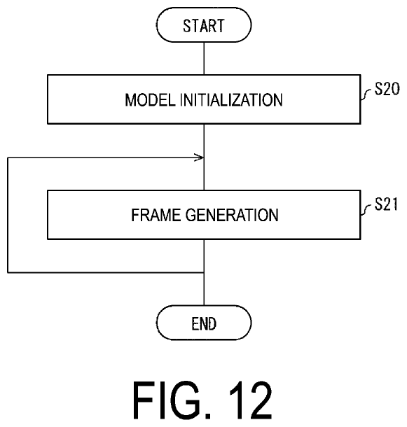

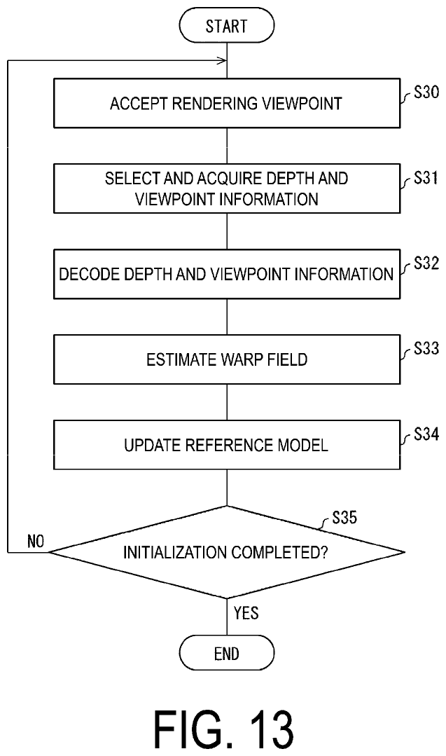

An image processing method by the image processing device 11 according to the present embodiment will be described below with reference to FIG. 12 and FIG. 13. FIG. 12 is a flowchart for illustrating an overview of the image processing method by the image processing device 11 according to the present embodiment. The frame generation of step S21 in FIG. 12 is similar to the steps of step S10 to step S17 described above. As illustrated in FIG. 12, the frame generation of step S21 is performed repeatedly. FIG. 13 is a flowchart that more specifically illustrates model initialization of step S20 illustrated in FIG. 12. That is, in the present embodiment, the steps of step S30 to S35 described below are performed prior to performing the above-described steps of step S10 to S17.

First, the reception unit 5 receives a rendering viewpoint (information related to the rendering viewpoint) from the outside of the image processing device 11 (step S30). Note that the rendering viewpoint is a viewpoint at the start of reproduction, and thus is also referred to as a starting rendering viewpoint. The reception unit 5 transmits the received rendering viewpoint to the acquisition unit 4, the viewpoint depth generation unit 7, and the rendering viewpoint image generation unit 8.

Next, the acquisition unit 4 acquires the depth that partially indicates the three-dimensional shape of the display target (the partial 3D model data associated with the order in the prescribed sequence), and information related to the viewpoint of the depth (viewpoint information) (step S31). More specifically, the acquisition unit 4 selects and acquires depth and viewpoint information for the initial reference model construction in accordance with the rendering viewpoint received by the reception unit 5. Note that in step S31, unlike step S1 or step S11 described above, the acquisition unit 4 may acquire the multiple partial 3D model data indicating a portion of the three-dimensional shape of the display target at a time. In step S31, the acquisition unit 4 may further acquire image data of the display target in addition to the depth and the viewpoint information.

Next, the acquisition unit 4 decodes the acquired depth and the viewpoint information corresponding to the depth (step S32). Then, the acquisition unit 4 transmits the decoded depth and viewpoint information to the estimation unit 9.

Next, the estimation unit 9 references the depth and viewpoint information, and the reference model updated immediately before by the update unit 6, in the order associated with the depth received from the acquisition unit 4, and estimates a warp field indicating a positional relationship between the reference model and the 3D model (live model) at a time point corresponding to the depth (step S33). Note that in a case that step S33 has not been performed once and there is not yet the immediately updated reference model, step S33 and the following step S34 may be omitted, and step S35 and subsequent steps may be performed by using the depth acquired by the acquisition unit 4 as a reference model.

Next, the update unit 6 updates the reference model with reference to the warp field estimated by the estimation unit 9 (step S34).

Next, the update unit 6 determines whether the initialization of the reference model has been completed (step S35) by the reference model updated in step S34, and in a case that the initialization has been completed (YES in step S35), the process proceeds to step S10 described above, and in a case of determining that the initialization has not been completed (NO in step S35), the process returns to step S30. The steps of step S30 to step S35 are repeatedly performed until the update unit 6 determines that the initialization has been completed. Then, the update unit 6 configures the reference model at the time that the initialization is completed to the initial reference model.

### Preferentially Acquired Depth

A specific example of depth and viewpoint information used for generation of the initial reference model, which the acquisition unit 4 acquires in accordance with the starting rendering viewpoint in step S31 described above, will be described below.

For example, in step S31, the acquisition unit 4 selects and acquires the image data and the depth of the viewpoint closest to the position of the starting rendering viewpoint p_{c} from among the image group {Vₛₘ} and depth group {Vₛₙ} available at the transmission source server.

In another example, in step S31, the acquisition unit 4 preferentially selects and acquires a depth that is effective for the construction of the reference model. More specifically, the acquisition unit 4 preferentially selects the depth of the viewpoint position that is not selected immediate before among the depths of viewpoint that is near the starting rendering viewpoint received from the reception unit 5. This can improve the accuracy of the initial reference model by acquiring and integrating depths of different viewpoint positions.

In another example, in step S31, in a case that the acquisition unit 4 selects and acquires two or more depths, one preferentially selects and acquires the depth of the viewpoint position near the starting rendering viewpoint and the other preferentially selects the depth of the viewpoint position that is less frequently acquired.

### Specific Example of Embodiment 3

A specific example of Embodiment 3 will be described below in detail. For example, the above-described steps S31 to S34 are repeatedly performed for a prescribed period of time, based on the starting position of the rendering viewpoint (starting rendering viewpoint position) received by the reception unit 5 in step S30 described above. In this configuration, the acquisition unit 4 acquires the depth for the prescribed frames, and the update unit 6 updates the reference model based on the depth, thereby completing the initialization of the reference model. This achieves an effect that the initial reference model is accurate for the display target and the image quality is improved.

In step S31, the acquisition unit 4 may select and acquire the depth (depth of the intermediate viewpoint position) of the viewpoint position near the starting rendering viewpoint position. Examples of the viewpoint positions near the starting rendering viewpoint position here include a viewpoint position within a prescribed distance from the starting rendering viewpoint position, N viewpoint positions in an order closer from the starting rendering viewpoint position, and each one viewpoint position from viewpoint positions that exist on top, bottom, left, and right centered on the starting rendering viewpoint position. In the configuration described above, the acquisition unit 4 may acquire the depths of the viewpoints that exist on the prescribed trajectory centered on the starting rendering viewpoint position in order. By employing the configuration described above, the reference model can be constructed based on the depth of the viewpoint that is present in the region where the rendering viewpoint is likely to move after the start of reproduction, and thus the effect is achieved that the image quality after the start of reproduction is stable.

In step S31, the acquisition unit 4 may acquire a list of the depth data in accordance with the starting rendering viewpoint position (the rendering viewpoint position received by the reception unit 5 in step S30) as the viewpoint information from the transmission source server. This achieves an effect that the number of depth data required for reference model construction can be reduced and the time required for the initialization of the reference model can be shortened because the depth of the viewpoint position effective for the reference model construction can be selected on the server side.

In step S31, the acquisition unit 4 may acquire a depth of a different time than the reproduction starting time, which is the time of the rendering viewpoint received by the reception unit 5 in step S30. This has the effect that the occlusion portion of the display target at a specific time can be modeled.

### Summary of Embodiment 3

As described above, the display device 10 including the image processing device 11 according to the present embodiment acquires the multiple partial 3D model data for the initial reference model construction at the start of processing, and generates the initial reference model, which is the reference model at the start of reproduction (display start), with reference to the multiple partial 3D model data for the initial reference model construction. This ensures the image quality at the start of reproduction of the rendering viewpoint image because a high-quality reference model can be constructed at the start of reproduction. Even in a case that the depth corresponding to the new rendering viewpoint cannot be received due to abrupt changes in the rendering viewpoint. an extreme reduction in quality of the rendering viewpoint image can be avoided by fall back to the reference model already constructed.

### Embodiment 4

Embodiment 4 of the present invention will be described below with reference to the drawings. Note that members having the same functions as the members included in the image processing device 2 or the image processing device 11 described in Embodiments 1 to 3 are denoted by the same reference signs, and descriptions thereof will be omitted.

### Image Processing Device 21

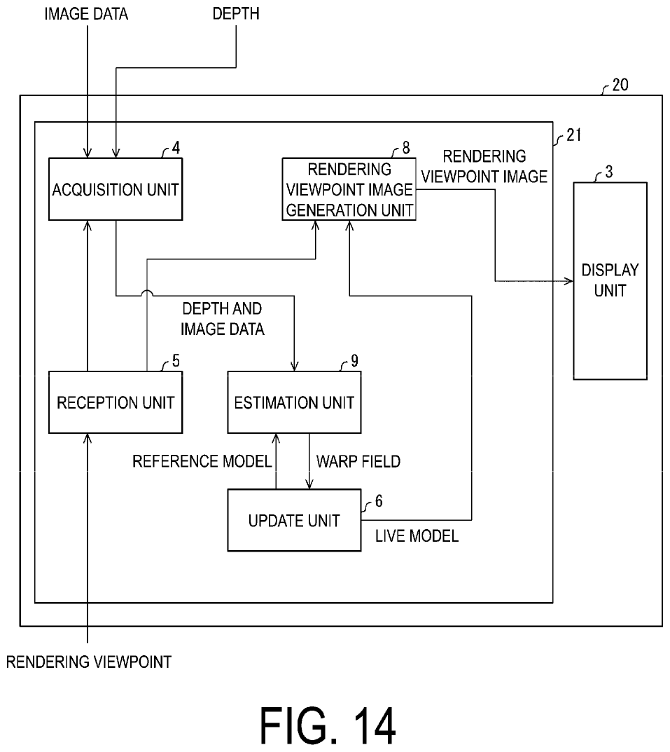

An image processing device 21 according to the present embodiment will be described with reference to FIG. 14. FIG. 14 is a block diagram illustrating a configuration of a display device 20 according to the present embodiment. As illustrated in FIG. 14, the display device 20 does not include the viewpoint depth generation unit 7 in the image processing device 21 compared to the display device 10 illustrated in FIG. 4. Therefore, for other members, the display device 20 includes members similar to the members included in the display device 10 illustrated in FIG. 4. Therefore, these members are denoted by the same reference signs, and descriptions thereof will be omitted.

An image processing method by the image processing device 21 according to the present embodiment will be described below. The image processing method of the present embodiment is the same as the image processing method described in Embodiment 2, except for steps of step S14 to step S17. Therefore, description of the steps other than step S14 to step S17 will be omitted.

First, in the image processing method of the present embodiment, instead of step S14, the estimation unit 9 references the depth and image data, and the reference model updated immediately before by the update unit 6, in the order associated with the depth (which may include viewpoint information) received from the acquisition unit 4, and estimates a warp field indicating a positional relationship between the reference model and the 3D model (live model) at a time point corresponding to the depth and the image data.

Next, similar to step S15, the update unit 6 updates the reference model with reference to the warp field estimated by the estimation unit 9. More specifically, the update unit 6 updates the reference model by converting the depth, based on the warp field. The live model generated in this step and the updated reference model include color information for each pixel indicated by the image data.

Next, without performing the step of step S16, the process proceeds to a step corresponding to step S17. In this step, the rendering viewpoint image generation unit 8 generates a rendering viewpoint image representing the display target from the rendering viewpoint, with reference to the rendering viewpoint received from the reception unit 5 and the live model received from the update unit 6.

### Summary of Embodiment 4

As described above, the image processing device 21 according to the present embodiment updates the reference model with further reference to the image data. This allows construction of a reference model including the information of the image data. Accordingly, even in a case that switching of image data takes time, a rendering viewpoint image without failure can be generated because the reference model that includes the information of the image data can be referenced.

### Embodiment 5

Embodiment 5 of the present invention will be described below with reference to the drawings. Note that members having the same functions as the members included in the image processing device 2, the image processing device 11, or the image processing device 21 described in Embodiments 1 to 4 are denoted by the same reference signs, and descriptions thereof will be omitted.

### Image Processing Device 31

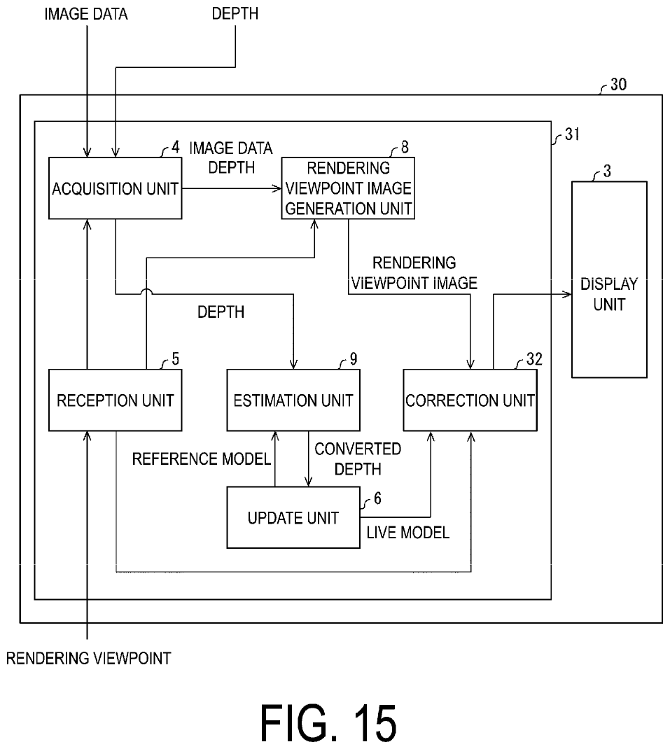

An image processing device 31 according to the present embodiment will be described with reference to FIG. 15. FIG. 15 is a block diagram illustrating a configuration of a display device 30 according to the present embodiment. As illustrated in FIG. 15, the display device 30 includes a correction unit 32 in place of the viewpoint depth generation unit 7 in the image processing device 31 in comparison to the display device 10 illustrated in FIG. 4. Therefore, for other members, the display device 30 includes members similar to the members included in the display device 10 illustrated in FIG. 4. Therefore, these members are denoted by the same reference signs, and descriptions thereof will be omitted.

The correction unit 32 included in the image processing device 31 according to the present embodiment performs image complementation or filtering on the rendering viewpoint image generated by the rendering viewpoint image generation unit 8 with reference to the rendering viewpoint received by the reception unit 5 and the live model generated by the update unit 6.

### Image Processing Method

An image processing method by the image processing device 31 according to the present embodiment will be described below. The image processing method of the present embodiment is the same as the image processing method described in Embodiment 2, except for steps of step S16 and step S17. Therefore, description of the steps other than step S16 to step S17 will be omitted.

First, in the image processing method of the present embodiment, instead of step S16, the rendering viewpoint image generation unit 8 generates the rendering viewpoint image representing the display target from the rendering viewpoint with reference to the image data and depth received from the acquisition unit 4 (which may include viewpoint information).

Next, instead of step S17, the correction unit 32 performs image complementation or filtering on the rendering viewpoint image generated by the rendering viewpoint image generation unit 8 with reference to the rendering viewpoint received by the reception unit 5 and the live model generated by the update unit 6. More specifically, the correction unit 32 converts the live model in accordance with the rendering viewpoint, and performs interpolation processing to fill a hole region of the rendering viewpoint image with reference to the converted live model. The correction unit 32 compares the image obtained by projecting the live model to the rendering viewpoint with the rendering viewpoint image, and applies a smoothing filter to the region on the rendering viewpoint image with different characteristics.

### Summary of Embodiment 5

As described above, the image processing device 31 according to the present embodiment references the image data and the multiple partial 3D model data to generate the rendering viewpoint image representing the display target from the rendering viewpoint, and performs image complementation or filtering on the rendering viewpoint image with reference to the reference model. This allows the existing DIBR based reproduction image generation system to be extended with a few modifications, since the configuration of generating the rendering viewpoint image with reference to the image data and the multiple partial 3D model data is similar to existing DIBR based reproduction image generation systems. In the expanded system, a high-quality rendering viewpoint image can be generated by performing image complementation or filtering on the rendering viewpoint image with reference to the reference model.

### Embodiment 6

Embodiment 6 of the present invention will be described below with reference to the drawings. Note that the image processing device 11 according to Embodiment 2 described above can also be used in the present embodiment. Therefore, in the following description, the display device 10 provided with the image processing device 11 illustrated in FIG. 4 will be used, and descriptions of each member provided by the display device 10 will be omitted. Note that, with respect to the data A in FIG. 4, in the present embodiment, the acquisition unit 4 does not acquire the data A such as depth. With respect to the data B in FIG. 4, the data received by the estimation unit 9 from the acquisition unit 4 is only image data.

An image processing method according to the present embodiment will be described below. The image processing method of the present embodiment is the same as the image processing method described in Embodiment 2, except for steps of step S11 to step S14. Therefore, the steps other than step S11 to step S14 will be omitted.

First, instead of step S11, the acquisition unit 4 acquires the image data of the display target.

Next, similar to step S12, the acquisition unit 4 selects the image data to be decoded in the acquired image data in accordance with the rendering viewpoint received by the reception unit 5.

Next, instead of step S13, the acquisition unit 4 decodes the selected image data.

Next, prior to performing step S14, the estimation unit 9 references the image data received from the acquisition unit, and estimates the depth (which may include viewpoint information) of the display target indicated by the image data. More specifically, the estimation unit 9 records a pair of image data in the estimation unit itself and a rendering viewpoint and derives the depth of the rendering viewpoint with reference to the most recent image data and the past image data. The derivation may be performed by applying techniques such as stereo matching, for example.

Next, the estimation unit 9 references the estimated depth (which may include viewpoint information) and the reference model updated immediately before by the update unit 6, and estimates a warp field indicating a positional relationship between the reference model and the 3D model (live model) at a time point corresponding to the depth.

### Summary of Embodiment 6

As described above, the image processing device 11 according to the present embodiment references image data to estimate the multiple partial 3D model data that partially indicate the three-dimensional shape of the display target. This achieves an effect that the preparation of the depth is not required on the transmission side.

### Supplemental Note

Hereinafter, a common supplemental note to each of the configurations described in Embodiments 1 to 6 will be described. In each of the above-described configurations, the update unit 6 continues to update the reference model until the reproduction of the video ends, but may cancel the reference model as necessary and construct the reference model again from the beginning. As an example of this configuration, for example, the time at which random access is possible is specified, and at the time when the acquisition unit 4 starts to acquire the partial 3D model data by random access, the update unit 6 resets the reference model updated immediately before.

The reference model updated by the update unit 6 need not necessarily be a model that directly represents an object within the scene. For example, the position and shape of a plane or curved surface corresponding to a foreground or background in the scene is also included in the reference model.

### Image Transmission Device

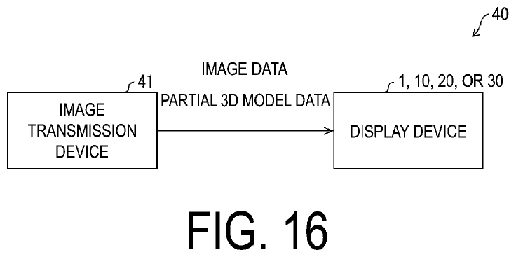

Hereinafter, an image transmission device that transmits the partial 3D model data acquired by the acquisition unit 4 in each of the configurations described in Embodiments 1 to 6 will be described with reference to FIG. 16. FIG. 16 is a block diagram illustrating a configuration of an image transmission and/or reception system 40 that includes the above-described display device 1, 10, 20 or 30 and the image transmission device 41 (also serving as the transmitter in the claims).

In the image transmission and/or reception system 40 illustrated in FIG. 16, the image transmission device 41 transmits image data of a display target and multiple partial 3D model data that partially indicate the three-dimensional shape of the display target. More particularly, the image transmission device 41 transmits multiple partial 3D model data that partially indicate a three-dimensional shape of the display target, the multiple partial 3D model data being associated with an order in a prescribed sequence.

Note that in above-described Embodiments 1 to 3, a configuration has been described in which the acquisition unit 4 preferentially acquires specific partial 3D model data. A configuration similar to these configurations can also be applied to the image transmission device 41. More particularly, the image transmission device 41 may preferentially transmit at least one or more data of partial 3D model data that indicates a portion of the display target relative to the rendering viewpoint, partial 3D model data that indicates a portion of the display target relative to the initial viewpoint of the rendering viewpoint, and partial 3D model data that indicates a portion of the display target relative to a prescribed viewpoint (for example, a recommended viewpoint), among the multiple partial 3D model data.

For example, the image transmission device 41 transmits the viewpoint information related to the viewpoint of the depth along with the depth that partially indicates the three-dimensional shape of the display target. In this configuration, the image transmission device 41 may transmit the depth in the sequence corresponding to the viewpoint of the depth indicated by the viewpoint information as a sequence of depth transmitted in the multiple depths.

### Implementation Examples by Software

The control blocks of the image processing devices 2, 11, 21 and 31 (in particular, the acquisition unit 4 and the update unit 6) may be achieved with a logic circuit (hardware) formed as an integrated circuit (IC chip) or the like, or may be achieved with software.

In the latter case, the image processing devices 2, 11, 21 and 31 include a computer that executes instructions of a program that is software implementing each function. The computer includes, for example, at least one processor (control device) and includes at least one computer-readable recording medium having the program stored thereon. In the above-described computer, the processor reads from the recording medium and performs the program to achieve the object of the present invention. For example, a Central Processing Unit (CPU) can be used as the processor. As the above-described recording medium, a “non-transitory tangible medium” such as a tape, a disk, a card, a semiconductor memory, and a programmable logic circuit can be used in addition to a Read Only Memory (ROM), for example. The device may further include a Random Access Memory (RAM) for deploying the program described above. The above-described program may be supplied to the above-described computer via an arbitrary transmission medium (such as a communication network and a broadcast wave) capable of transmitting the program. Note that one aspect of the present invention may also be implemented in a form of a data signal embedded in a carrier wave in which the program is embodied by electronic transmission.

### Supplement

An image processing device (2, 11, 21, 31) according to Aspect 1 of the present invention includes: an acquisition unit (4) configured to acquire multiple pieces of partial 3D model data that partially indicate a three-dimensional shape of a display target, the multiple pieces of partial 3D model data being associated with an order in a prescribed sequence; a first generation unit (update unit 6) configured to generate a reference model with reference to the multiple pieces of partial 3D model data; and a second generation unit (rendering viewpoint image generation unit 8) configured to generate a rendering viewpoint image representing the display target from a rendering viewpoint with reference to the reference model, wherein the first generation unit updates the reference model with reference to the multiple pieces of partial 3D model data in the order associated with the multiple pieces of partial 3D model data.

According to the above-described configuration, by acquiring the multiple pieces of partial 3D model data that partially indicate the three-dimensional shape of the display target, the amount of data of the acquired 3D model data can be reduced compared to a case that the 3D model data indicating the entire three-dimensional shape of the display target is received at each time point. According to the above-described configuration, by updating the reference model with reference to the multiple pieces of partial 3D model data in the order associated with the multiple pieces of partial 3D model data, deterioration in quality of the rendering viewpoint image due to the number of samples or the accuracy of the 3D model data can be prevented, and a high-quality rendering viewpoint image can be generated.

In an image processing device (2, 11, 21, 31) according to Aspect 2 of the present invention, in above-described Aspect 1, each of the multiple pieces of partial 3D model data may be data of at least one or more of a depth, a point cloud, or a mesh that partially indicate the three-dimensional shape of the display target.

According to the above configuration, the reference model can be preferably constructed, and a high-quality rendering viewpoint image can be generated.

In an image processing device (2, 11, 21, 31) according to Aspect 3 of the present invention, in Aspect 1 or 2, the acquisition unit may preferentially acquire, among the multiple pieces of partial 3D model data, at least one or more of a piece of partial 3D model data indicating a portion of the display target relative to an initial viewpoint or a piece of partial 3D model data indicating a portion of the display target relative to a recommended viewpoint.

According to the above-described configuration, the partial 3D model data necessary for the generation of the rendering viewpoint video can be prepared as appropriate.

An image processing device (2, 11, 21, 31) according to Aspect 4 of the present invention may acquire, in Aspect 1 or 2, the multiple pieces of partial 3D model data without depending on the rendering viewpoint.

According to the above-described configuration, by generating the reference model by the multiple pieces of partial 3D model data that does not depend on the rendering viewpoint, even in a case that the history of the past rendering viewpoint is different, the effect is achieved that the reproduction results of the video at the same time and in the same viewpoint will be the same in a case that the same multiple pieces of partial 3D model data is acquired.

In an image processing device (2, 11, 21, 31) according to Aspect 5 of the present invention, in above-described Aspects 1 to 4, the acquisition unit may acquire the multiple pieces of partial 3D model data for an initial reference model construction, and the first generation unit may generate an initial reference model with reference to the multiple pieces of partial 3D model data for the initial reference model construction.

The above-described configuration ensures image quality at the start of reproduction of the rendering viewpoint image to construct the initial reference model prior to the start of reproduction of the rendering viewpoint image. Even in a case that the depth corresponding to the new rendering viewpoint cannot be received due to abrupt changes in the rendering viewpoint. an extreme reduction in quality of the rendering viewpoint image can be avoided by fall back to the initial reference model already constructed.

In an image processing device (11, 21, 31) according to Aspect 6 of the present invention, in above-described Aspect 4, the multiple pieces of partial 3D model data are multiple depths that partially indicate the three-dimensional shape of the display target, and the first generation unit (estimation unit 9) refers to the multiple depths and the reference model in the order associated with the multiple depths to estimate a warp field indicating a positional relationship between the reference model and another reference model corresponding to the multiple depths, and updates the reference model with reference to the warp field.

According to the above-described configuration, a reference model can be constructed in which noise is canceled in real time from the depth, and thus a high-quality rendering viewpoint image can be generated.

An image processing device (11, 21, 31) according to Aspect 7 of the present invention may acquire, in above-described Aspect 6, the multiple depths described above and viewpoint information related to viewpoints of the multiple depths.

According to the above-described configuration, the depth can be selected and acquired depending on the viewpoint of depth indicated by the viewpoint information, and thus the depth required for the construction of the reference model in accordance with the rendering viewpoint can be preferentially acquired. Thus, a high-quality rendering viewpoint image can be generated.

In an image processing device (11, 21, 31) according to Aspect 8 of the present invention, in above-described Aspect 7, in the acquisition unit, the order associated with the multiple depths may be an order in an sequence corresponding to viewpoints of the multiple depths indicated by the viewpoint information, and the sequence may be a sequence in which a depth of the multiple depths at a viewpoint of the viewpoints away from a viewpoint of the viewpoints for a depth of the multiple depths preceding in the order is prioritized as a depth of the multiple depths succeeding in the order.

According to the above-described configuration, an overview of the model shape of the display target can be constructed in a short time.

In an image processing device (2, 11, 21 and 31) according to Aspect 9 of the present invention, in above-described Aspects 1 to 8, the acquisition unit may further acquire image data of the display target, and the first generation unit may update the reference model with further reference to the image data.

According to the above-described configuration, a reference model including information of image data can be constructed. Accordingly, even in a case that switching of image data takes time, a rendering viewpoint image without failure can be generated because the reference model that includes the information of the image data can be referenced.

An image processing device (31) according to Aspect 10 of the present invention includes: an acquisition unit configured to acquire image data of a display target and multiple pieces of partial 3D model data that partially indicate a three-dimensional shape of the display target, the multiple pieces of partial 3D model data being associated with an order in a prescribed sequence; a first generation unit configured to generate a reference model with reference to the multiple pieces of partial 3D model data; a second generation unit configured to generate a rendering viewpoint image representing the display target from a rendering viewpoint with reference to the image data and the multiple pieces of partial 3D model data; and a correction unit configured to perform image complementation or filtering on the rendering viewpoint image with reference to the reference model, wherein the first generation unit updates the reference model with reference to the multiple pieces of partial 3D model data according to the order associated with the multiple pieces of partial 3D model data.

According to the above-described configuration, the existing DIBR based reproduction image generation system can be extended with a few modifications, as the configuration of generating the rendering viewpoint image with reference to the image data and the multiple partial 3D model data is similar to existing DIBR based reproduction image generation systems. In the expanded system, a high-quality rendering viewpoint image can be generated by performing image complementation or filtering on the rendering viewpoint image with reference to the reference model.

An image processing device (11) according to Aspect 11 of the present invention includes: an acquisition unit configured to acquire image data of a display target; an estimation unit configured to estimate multiple pieces of partial 3D model data that partially indicate a three-dimensional shape of the display target with reference to the image data; a first generation unit configured to generate a reference model with reference to the multiple pieces of partial 3D model data; and a second generation unit configured to generate a rendering viewpoint image representing the display target from a rendering viewpoint with reference to the image data and the reference model, wherein the first generation unit updates the reference model with reference to the multiple pieces of partial 3D model data, each time the estimation unit estimates each of the multiple pieces of partial 3D model data.

According to the above-described configuration, a reference model including color information for each pixel indicated by image data can be constructed. Accordingly, even in a case that switching of image data takes time, a rendering viewpoint image without failure can be generated because the reference model that includes the information of the image data can be referenced.

A display device (1, 10, 20, 30) according to Aspect 12 of the present invention includes the image processing device according to any one of above-described Aspects 1 to 10, and a display unit (3) configured to display the rendering viewpoint image.

According to the above-described configuration, a high-quality rendering viewpoint image generated by the image processing device according to any one of above-described Aspects 1 to 10 can be displayed.

The image transmission device (41) according to Aspect 13 of the present invention includes a transmitter configured to transmit multiple pieces of partial 3D model data that partially indicate a three-dimensional shape of a display target, the multiple pieces of partial 3D model data being associated with an order in a prescribed sequence.

According to the above-described configuration, the amount of data of the 3D model data transmitted at each time point can be reduced compared to a case where the 3D model data indicating the entire three-dimensional shape of the display target is transmitted at once.

An image processing method according to Aspect 14 of the present invention includes the steps of: acquiring multiple pieces of partial 3D model data that partially indicate a three-dimensional shape of a display target, the multiple pieces of partial 3D model data being associated with an order in a prescribed sequence; generating a reference model with reference to the multiple pieces of partial 3D model data; and generating a rendering viewpoint image representing the display target from a rendering viewpoint with reference to the reference model, wherein the step of generating the reference model updates the reference model with reference to the multiple pieces of partial 3D model data according to the order associated with the multiple pieces of partial 3D model data.

According to the above-described configuration, the same effect as that of Aspect 1 can be achieved.

The image processing device according to each of the aspects of the present invention may be implemented by a computer. In this case, the present invention embraces also a control program of the image processing device that implements the above image processing device by a computer by causing the computer to operate as each unit (software element) included in the above image processing device, and a computer-readable recording medium recording the program.

The present invention is not limited to each of the above-described embodiments. It is possible to make various modifications within the scope of the claims. An embodiment obtained by appropriately combining technical elements each disclosed in different embodiments falls also within the technical scope of the present invention. Further, combining technical elements disclosed in the respective embodiments makes it possible to form a new technical feature.

### CROSS-REFERENCE OF RELATED APPLICATION

This application claims the benefit of priority to JP 2017-154551 filed on Aug. 9, 2017, which is incorporated herein by reference in its entirety.

### REFERENCE SIGNS LIST

1, 10, 20, 30 Display device
2, 11, 21, 31 Image processing device
3 Display unit
4 Acquisition unit
5 Reception unit
6 Update unit
7 Viewpoint depth generation unit
8 Rendering viewpoint image generation unit
9 Estimation unit
32 Correction unit
40 Image transmission and/or reception system
41 Image transmission device

1. An image processing device comprising:
an acquisition circuit configured to acquire multiple pieces of partial 3D model data that partially indicate a three-dimensional shape of a target, the multiple pieces of partial 3D model data being associated with an order in a prescribed sequence;
a first generation circuit configured to generate a reference model with reference to the multiple pieces of partial 3D model data; and
a second generation circuit configured to generate a rendering viewpoint image representing the target from a rendering viewpoint with reference to the reference model, wherein
the first generation circuit updates the reference model with reference to the multiple pieces of partial 3D model data according to the order associated with the multiple pieces of partial 3D model data, and
the acquisition circuit preferentially acquires, among the multiple pieces of partial 3D model data, at least one or more of a piece of partial 3D model data indicating a portion of the target relative to an initial viewpoint or a piece of partial 3D model data indicating a portion of the target relative to a recommended viewpoint.

2. The image processing device according to claim 1, wherein each of the multiple pieces of partial 3D model data is data of at least one or more of a depth, a point cloud, or a mesh that partially indicate the three-dimensional shape of the target.

3. (canceled)

4. (canceled)

5. The image processing device according to claim 1, wherein
the acquisition circuit acquires the multiple pieces of partial 3D model data for an initial reference model construction, and
the first generation circuit generates an initial reference model with to the multiple piece of partial 3D model data for the initial reference model construction.

6. An image processing device comprising:
an acquisition circuit configured to acquire multiple pieces of partial 3D model data that partially indicate a three-dimensional shape of a target, the multiple pieces of partial 3D model data being associated with an order in a prescribed sequence;
a first generation circuit configured to generate a reference model with reference to the multiple pieces of partial 3D model data; and
a second generation circuit configured to generate a rendering viewpoint image representing the target from a rendering viewpoint with reference to the reference model, wherein
the first generation circuit updates the reference model with reference to the multiple pieces of partial 3D model data according to the order associated with the multiple pieces of partial 3D model data,
the acquisition circuit acquires the multiple pieces of partial 3D model data without depending on the rendering viewpoint,
the multiple pieces of partial 3D model data are multiple depths that partially indicate the three-dimensional shape of the target, and
the first generation circuit refers to the multiple depths and the reference model its the order associated with the multiple depths to estimate a warp field indicating a positional relationship between the reference model and another reference model corresponding to the multiple depths, and updates the reference model with reference to the warp field.

7. The image processing device according to claim 6, wherein the acquisition circuit acquires the multiple depths and viewpoint information related to viewpoints of the multiple depths.

8. The image processing device according to claim 7, wherein
in the acquisition circuit, the order associated with the multiple depths is an order in a sequence corresponding to viewpoints of the multiple depths indicated by the viewpoint information, and
the sequence is a sequence in which a depth of the multiple depths at a viewpoint of the viewpoints away from a viewpoint of the viewpoints for a depth of the multiple depths preceding in the order is prioritized as a depth of the multiple depths succeeding in the order.

9. The image processing device according to claim 6, wherein
the acquisition circuit further acquires image data of the target, and
the first generation circuit updates the reference model with further reference to the image data.

10. (canceled)

11. (canceled)

12. A display device comprising:
the image processing device according to claim 1; and
a display circuit configured to display the rendering viewpoint image.

13-16. (canceled)
